(19) United States
(12) Patent Application Publication
(10) Pub. No.: US 2007/0079999 A1
(43) Pub. Date: Apr. 12, 2007

(54) Motorized wheelbarrow

(76) Inventor: Anthony M. Lamanna, Pittsburgh, PA (US)

Correspondence Address: Anthony M. Lamanna, 303 Forest Ridge Drive, Pittsburgh, PA, 15221, US

(21) Appl. No.: 11/543,418

(22) Filed: Oct. 5, 2006

Related U.S. Application Data
(60) Provisional application No. 60/724,720, filed on Oct. 8, 2005.

(51) Int. Cl. B62D 51/04

(52) U.S. Cl. 180/19.1

(57) ABSTRACT

A motorized wheelbarrow of traditional frame design employing a lightweight and small displacement engine to drive the front wheel of the wheelbarrow. A drive mechanism including a centrifugal clutch, enclosed gear reduction box and chain is operably linked to a sprocket on the wheel shaft and to a sprocket on the output shaft of the gear reduction box. The combination of the drive train components allows the operator to power the wheelbarrow at variable speeds via a single finger throttle trigger that links the engine and the user. This wheelbarrow maintains the attributes of the front mounted single-wheel wheelbarrow by having the engine and drive mechanism mounted behind the drive wheel and directly under the load carrying bucket.

### CROSS-REFERENCE TO RELATED APPLICATIONS

This application claims the benefit of provisional patent application No. 60/724,720.

### REFERENCES CITED

U.S Patent Documents

| | | |
|---|---|---|
| 4,589,508 | May 1986 | Hoover et al. |
| 4,811,988 | March 1989 | Emmel |
| 5,211,254 | May 1993 | Harris, III et al. |
| 5,284,218 | February 1994 | Rusher |
| 5,350,030 | September 1994 | Mawhinney et al. |
| 5,489,000 | February 1996 | Hillbohm |
| 5,878,827 | March 1999 | Power Technology |

### BACKGROUND OF THE INVENTION

1. Field of the Invention

The present invention relates to a wheelbarrow which is equipped with a small displacement engine and drive mechanism which is capable of propelling the wheelbarrow.

2. Description of the Related Art

The wheelbarrow as we know it was invented by the Chinese as early as 118 A.D. and arrived in the West around 1220 A.D. In its simplest form, the wheelbarrow consists of a front mounted single wheel, a support frame and load carrying bucket and combines the advantages of both the wheel and the lever. The load is centered just behind the single wheel allowing you to lift only a very small amount of the weight of the wheelbarrow. Moreover, the two handles give an intimacy of control you don't have with a four-wheeled cart.

Since its inception, the wheelbarrow has been refined to provide greater ease of operation and durability. Even with these refinements, the traditional wheelbarrow still has its drawbacks. The major drawback is that, upon lifting the wheelbarrow, the operator must still utilize force to push the loaded wheelbarrow from one location to another. Heretofore, multiple attempts have been made to eliminate this difficulty by motorizing the wheelbarrow through the use of a gasoline powered engine. While many of these prior attempts suffer from technological shortfalls, others fail to envision the needs of the end user.

It will become clear from the examples that follow that the focus of the motorized wheelbarrow has strayed away from the simplicity of the traditional wheelbarrow blueprint. For example, several patents for motorized wheelbarrows and “motorized carts” focus on the dumping aspect of the unit by incorporating a burdensome split frame. For instance, U.S. Pat. No. 4,589,508 issued to Hoover et al. discloses a motorized wheelbarrow utilizing a gasoline engine which drives a single front wheel through a friction drive transmission. The wheelbarrow incorporates a split frame whereby the bed of the wheelbarrow tilts without tilting the engine or transmission. This device places a burden on the user by making it difficult for him to gain leverage to dump the load. It also adds time to the dumping process. U.S. Pat. No. 4,811,988 issued to Erich Emmel discloses a four wheeled powered load carrier that also utilizes a hinged frame for dumping purposes. While attempting to make the hinged frame design more user friendly by having the upper frame slide on rollers, the overall operation of said unit is still awkward and, with the inclusion of four wheels, has been made impractical for use in rough terrain or in tight areas. U.S. Pat. No. 5,350,030 issued to Mawhinney et al. teaches a split frame motorized wheelbarrow with an off-center pivoting load bucket. This piece of equipment also includes four wheels as well as an onboard generator. In addition to the increased burden associated with dumping these units, they also suffer from weight issues associated with the additional wheels and split frames.

Other proposed wheelbarrows and carts focus on a front mounted engine location. For example, U.S. Pat. No. 5,284,218 issued to James T. Rusher, Jr. discloses a four wheeled cart with a front mounted engine. U.S. Pat. No. 5,489,000 issued to Lars Hillbohm also maintains a front mounted engine, but remains true to the single wheel in its version of the motorized wheelbarrow. This single wheel front mounted engine unit, however, jeopardizes the balanced design of the traditional wheelbarrow by placing weight forward of the front wheel. This leads to the potential for premature tipping of the barrow during its use.

Another major limiting factor with most proposed motorized wheelbarrows and carts is the clutch engagement system. Most of the patents have manually actuated clutches as opposed to centrifugal clutches. For example, U.S. Pat. No. 5,211,254 issued to Harris, III et al. discloses a motorized wheelbarrow employing a manually actuated clutch and multi-speed transmission. While boasting three gears, once engaged, the transmission will only produce one set speed depending on which gear is used. On the other hand, U.S. Pat. No. 5,878,827 issued to Power Technology Unlimited, Inc. discloses a drive train that includes a centrifugal clutch, but fails to discuss or specify the requirements of gear reduction and engine type.

The above examples demonstrate the limitations and disadvantages of these proposed wheelbarrows. Moreover, there begins to emerge clarity as to why such machines are not widely used. These motorized wheelbarrows are bulky, heavy, unbalanced, and difficult to operate in rough terrain. Many of them have burdensome split frames, heavy 4-cycle engines, impractical pulley and belt clutch systems, and no definitive way to reduce the engine speed to a walking pace. In addition, many of these proposed motorized wheelbarrows have strayed away from the simplicity of the wheelbarrow design and its mode of operation.

### BRIEF SUMMARY OF THE INVENTION

The object of the present invention is to provide a motorized wheelbarrow that eliminates the aforementioned limitations of existing motorized wheelbarrows. In doing so, the present invention provides for a lightweight motorized wheelbarrow which can be used in the same manner as a conventional non-motorized wheelbarrow but without the necessity to push the wheelbarrow after having been lifted. To achieve this goal, and in accordance with the purpose of the invention as embodied and described herein, a motorized wheelbarrow is provided comprising a frame having a pair of lightweight handles with each handle having a proximal and a distal end. A drive wheel is secured to the distal ends of the pair of handles. A rigid structure is secured to the frame for supporting the small displacement engine.

This new motorized wheelbarrow maintains the attributes of the front mounted single-wheel wheelbarrow by having the engine and drive mechanism mounted behind the drive wheel and directly under the load carrying bucket. The 2-cycle or 4-stroke small displacement engine allows for worry-free and effortless traditional dumping of the unit. The engine will never stall upon dumping and shaking due to its carburetor design. Just as important, advances in engine technology have provided these small displacement engines with adequate horsepower and torque all while reducing their size and weight.

A drive mechanism including a centrifugal clutch, enclosed gear reduction box, sprocket and chain is operably linked to a sprocket on the wheel shaft and to the output shaft of the gear reduction box. The combination of the drive train components allows the operator to power the wheelbarrow at variable speeds via a single finger throttle trigger that links the engine and the user. As the throttle is squeezed, the engine produces more torque and speed as needed for larger load size and increased walking speed. The centrifugal clutch and gear reduction box are fully enclosed and replace the traditional belt and pulley clutch system. A load bucket is mounted to the top of the lightweight frame and no rear wheels are included. No other proposed motorized wheelbarrow contains a grouping of the above described drive train components with a lightweight frame that emulates the design of a traditional wheelbarrow.

### BRIEF DESCRIPTION OF THE DRAWINGS

The accompanying drawings, which are incorporated in and constitute a part of the specification, illustrate a preferred embodiment of the invention and, together with a general description given above and the detailed description of the preferred embodiment given below, serve to explain the principles of the invention.

FIG. 1 is a left side elevational view of the present invention illustrating the enclosed gear reduction box, sprockets and chain.

FIG. 2 is a right side elevational view of the present invention illustrating the small displacement engine and throttle mechanism.

FIG. 3 is a top view of the present invention with bucket removed illustrating placement of small displacement engine, components of drive mechanism, and drive wheel.

### DETAILED DESCRIPTION OF THE INVENTION

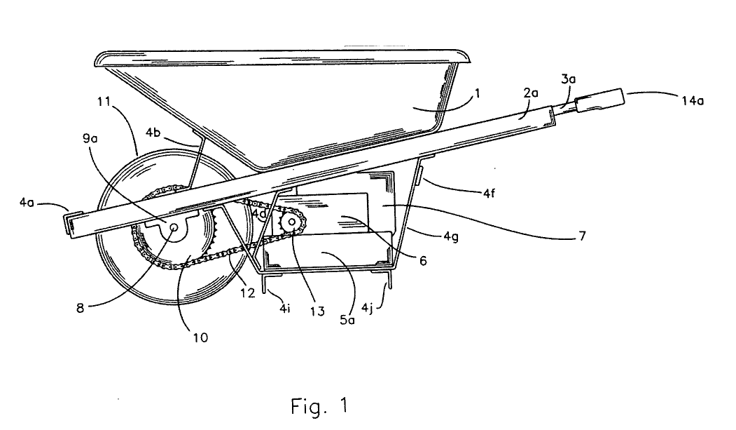

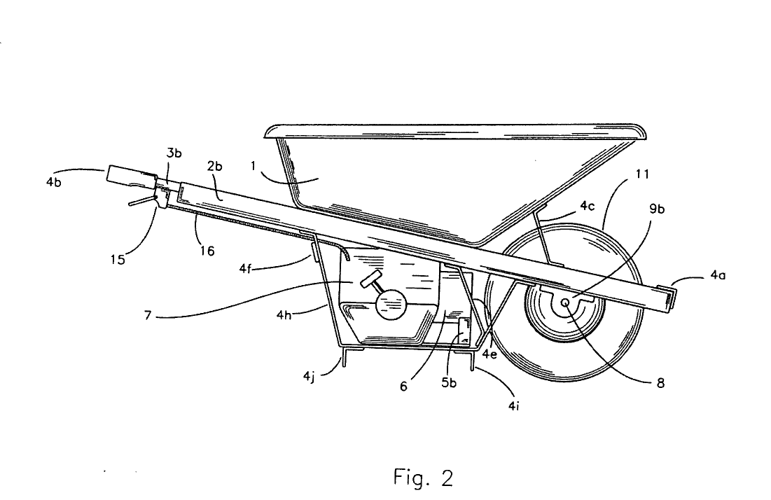

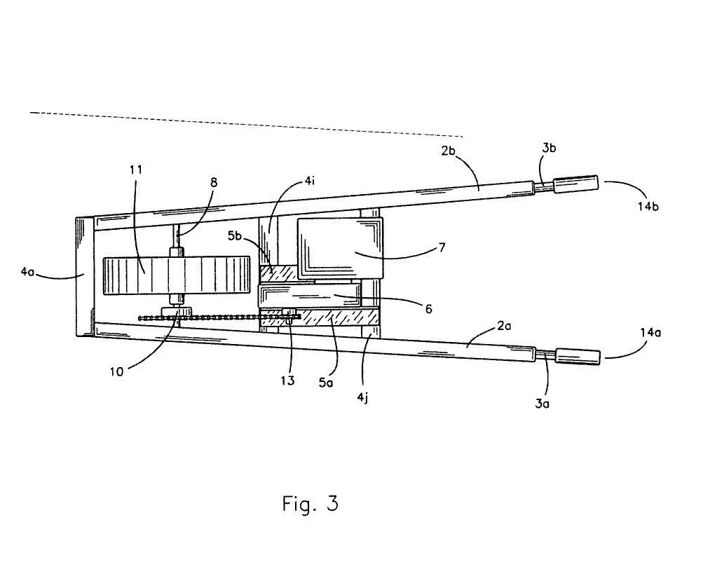

The Motorized Wheelbarrow in its preferred embodiment is shown in FIGS. 1, 2 and 3. References made in the following paragraphs will be made with respect to all three drawings.

The bucket 1 is utilized to carry the load to be transported by the user. The bucket is made of a poly or steel material and is attached to frame tubing 2a and 2b. The bucket may be embodied as shown or may be constructed as a flat bed or other shape depending on the application for which it will be used.

The bucket 1 is further supported by structural elements 4b and 4c. The cylindrically shaped handles 3a and 3b are attached to the frame tubing 2a and 2b by welding and/or bolts and nuts. Handle grips 14a and 14b then slide over the handles to ensure comfortable use of the motorized wheelbarrow by the end user. Structural element 4a connects frame tubing 2a and 2b to provide strength and rigidity.

Pillow block bearings 9a and 9b are attached to underneath side of frame tubing 2a and 2b. The pillow block bearings provide smooth rolling action of drive shaft 8. The inner race of each pillow block bearing is secured to the drive shaft via two set screws. The drive sprocket 10 and front wheel 11 are connected to the drive shaft by keyway and setscrew or by welding.

The engine 7 combines the elements of a pull start, on/off switch, and centrifugal clutch. The engine must be of a design to operate in any position or rotation and may be of 2-cycle or 4-cycle design. Engine 7 typically incorporates an integral fuel tank located at the base of the engine. This enables easy fueling without removal of the bucket. Throttle control 15 is used to control the speed of engine 7 and therefore the speed of the motorized wheelbarrow. Position of throttle control 15 is transferred to engine 7 through throttle control cable 16.

The gearbox 6 is bolted directly to engine 7. Power from engine 7 is transferred to gearbox 6 through the centrifugal clutch, which is integral to the engine 7, and centrifugal clutch drum, which is integral to the gearbox 6. Gearbox 6 increases torque produced by the engine. Sprocket 13 is attached to the output shaft of gearbox 6 by means of keyway and setscrews or welding. Sprockets 10 and 13 are connected by chain 12. This allows the power from engine 7 to be transferred to wheel 11 through gearbox 6, sprocket 13, chain 12, sprocket 10, and finally shaft 8.

Mounting brackets 5a and 5b are bolted to the gearbox. The mounting brackets are attached to the rigid structure that is formed by structural members 4d, 4e, 4g, 4h, 4i, 4j, and 4f. Structural members are attached to each other by welding or by mechanical fastening such as bolts, nuts, rivets, screws, etc. Structural members may be made of either high strength aluminum or steel depending on whether weight or formability is desired.

In the preferred embodiment, the wheelbarrow has only one front wheel but may incorporate two front wheels to add stability.

Additionally, the preferred embodiment utilizes drag from the gearbox as a braking mechanism. Alternatively, a free wheel device may be utilized to eliminate gearbox drag when the motorized wheelbarrow is pushed by hand rather than motivated by the engine. The device may be positioned on the drive shaft or gearbox shaft. If utilized in this manner, a hand brake composed of a disk, calipers, control cable, and squeeze control may be required to provide the braking force.

The invention is not limited to the preferred embodiments described and many potential versions are possible. The invention is therefore not limited to specific details shown and described.

I claim:

1. A motorized wheelbarrow, comprising:
a frame including a pair of spaced handles each having a proximal and distal end and a pair of downwardly depending structural support elements;
a wheel secured to the distal ends of the pair of handles by frame elements for bearing the load of said wheelbarrow when the proximal ends of said handles are lifted;
a mounting element secured to said frame for supporting a drive engine;
said drive engine mounted behind the drive wheel and directly under the load carrying bucket;
a drive mechanism including a centrifugal clutch, gear reduction box and chain operably linked to a sprocket on the wheel shaft and to a sprocket on the output shaft of the gear reduction box;
a throttle mechanism being operably engaged to said drive engine; and
a load bucket secured to said frame.

2. The motorized wheelbarrow of claim 1, wherein said drive engine is a gasoline powered engine.

3. The motorized wheelbarrow of claim 2, wherein said gasoline powered engine can be rotated in all directions.

4. The motorized wheelbarrow of claim 1, wherein said centrifugal clutch is integral to said gasoline powered engine.

5. The motorized wheelbarrow of claim 1, wherein said gear reduction box is fully enclosed.

6. The motorized wheelbarrow of claim 5, wherein said gear reduction box includes an integral centrifugal clutch drum.

7. The motorized wheelbarrow of claim 1, wherein said means connecting said gear reduction box and said wheel comprises a sprocket and chain drive assembly.

8. The motorized wheelbarrow of claim 1, wherein said load bucket is composed of polyurethane.
